(19) United States
(12) Patent Application Publication
(10) Pub. No.: US 2026/0246217 A1
(43) Pub. Date: Aug. 20, 2026

(54) HAND PLIERS DESIGNED TO CARRY OUT CRIMPING, AND HAND PLIERS COMPRISING A PLIER HEAD

(71) Applicant: Rennsteig Werkzeuge GmbH, Steinbach-Hallenberg (DE)

(72) Inventors: Georg HOLLAND-MORITZ, Steinbach-Hallenberg (DE); Benjamin WEISHEIT, Floh-Seligenthal (DE); Michael BRUECKNER, Steinbach-Hallenberg (DE)

(73) Assignee: Rennsteig Werkzeuge GmbH, Steinbach-Hallenberg (DE)

(21) Appl. No.: 18/017,473

(22) PCT Filed: Aug. 18, 2021
(86) PCT No.: PCT/EP2021/072939

§ 371 Date: Jan. 23, 2023

(30) Foreign Application Priority Data
Aug. 20, 2020 (DE) 10 2020 121 823.0

(51) Int. Cl. H01R 43/042

(52) U.S. Cl. CPC H01R 43/0421

(57) ABSTRACT

Hand pliers which are designed to carry out crimping and have one stationary and one moving plier leg and a first and a second crimping jaw, wherein the first crimping jaw is acted upon by a drive tappet. The second crimping jaw can be moved back inside a crimping jaw receptacle in the hand pliers against spring force. A plier head is formed by mutually pivotable plier jaws that interact, for example for stripping, wherein: the plier head has a broad side, a narrow side, and an end face; a pivot axis of the plier jaws extends at right angles to an extent of the broad side, and the narrow side extends approximately at right angles to the broad side; and crimping jaws for carrying out crimping.

### CROSS REFERENCE TO RELATED APPLICATIONS

This application is the National Stage of PCT/EP2021/072939 filed on Aug. 18, 2021, which claims priority under 35 U.S.C. § 119 of German Application No. 10 2020 121 823.0 filed on Aug. 20, 2020, the disclosure of which is incorporated by reference. The international application under PCT article 21 (2) was not published in English.

### TECHNICAL FIELD

The invention relates in the first instance to hand pliers designed to carry out crimping and having one stationary and one movable plier leg and a first and a second crimping jaw, wherein the first crimping jaw is acted upon by a drive tappet.

The invention further relates to hand pliers comprising a pliers head formed by mutually pivotable plier jaws which interact for stripping, wherein the pliers head has a broad side, a first and a second narrow side extending in a usual handling position on the upper and lower side substantially at right angles to the broad side, and an end face, wherein further a pivot axis of the plier jaws extends at right angles to an extent of the broad side, and the narrow side extends approximately at right angles to the broad side, wherein crimping jaws to carry out crimping are also provided.

### PRIOR ART

Hand pliers of the type in question are known, in particular for use as so-called crimping pliers for crimping or pressing pressed parts such as furthermore, for example, wire end ferrules to stripped ends of electrical cables. For example, reference is made to DE 10 2018 101 159 A1.

Moreover, hand pliers are known which are designed in particular as a pliers-like stripping tool, but at the same time also enable crimping, for example, of the previously stripped cable end with a wire end ferrule using the same tool. Such a hand tool is known, for example, from EP 0 540 880 B1 (U.S. Pat. No. 5,500,998).

Known from EP 3 396 796 A1 is a pressing, crimping or cutting tool in which a crimping jaw, for example, is supported in mechanical parallel connection via an elastic support element and a sensor. The aim is nevertheless to achieve the highest possible rigidity.

Known from U.S. Pat. No. 5,042,286 A is a pliers-like hand tool formed as a crimping tool in which a movable crimping jaw can be moved linearly relative to a stationary crimping jaw for crimping. According to one configuration, a locator associated with the stationary crimping jaw can be provided, the locator being movable against a compression spring.

Known from US 2019/0312397 A1 are hand pliers in which one stationary and one pivotable crimping jaw are provided. The hand pliers are designed for crimping only.

### SUMMARY OF THE INVENTION

Based on the prior art explained above, it is the object of the invention to advantageously design a hand tool as explained with a configuration that is favorable in terms of handling.

This object is achieved in the first instance with a hand tool in which first and the second crimping jaw are provided with ribs which partially engage in one another in a comb-like manner and which are triangular in shape when viewed in the direction of an insertion direction of a cable provided with a pressed part into a crimping opening, wherein in an unloaded basic position, this results in a crimping jaw that is rectangular in plan view, that the second crimping jaw can be moved back inside a crimping jaw receptacle of the hand pliers against a force, and that the first and the second crimping jaw are arranged in a common linear guide.

The spring force can be applied directly by the second crimping jaw, in particular by a segment of the second crimping jaw, or alternatively by a separate part. Thus, for example, the second crimping jaw can include, directly or indirectly, a spring element which acts correspondingly and furthermore, is formed thereon, for example. Moreover, the spring element applying the spring force can be an element separate from the second crimping jaw, for example a metal or plastic spring, for example in the form of a cylinder compression spring or a leg spring. Preferred in this respect is a plastic spring in the form of a solid element that can be elastically sprung in and out, further for example in the manner of a foam element. Further preferably, a polyurethane block element can serve in this respect as a spring element against which the second crimping jaw acts, in particular in the course of crimping.

The return movement or evasive movement of the second crimping jaw in the course of crimping, which is made possible against a spring force, enables crimping of pressed parts of different dimensions (possibly diameter) viewed in the direction of displacement, with substantially constant displacement travel of the movable plier leg which acts in particular on the first crimping jaw, preferably indirectly via the drive tappet. Accordingly, the user is provided with an at least approximately constant actuation travel of the hand pliers, in particular irrespective of a diameter of the pressed part to be pressed, for example a wire end ferrule. The different displacement distances, in particular of the first crimping jaw, which arise in dependence of, for example, a diameter of the pressed part, are made possible by the second crimping jaw which can move back against the spring force. Accordingly, the spring preferably acts in a distance-compensating manner.

Furthermore, as a result of the spring action on the second crimping jaw, the latter is displaced back into a possibly stop-limited basic position after carrying out crimping and an accompanying backward displacement. A coupled entrainment of the second crimping jaw via the first crimping jaw for the backward displacement of the second crimping jaw can be dispensed with.

This object is further achieved with a hand tool having a crimping opening formed by the crimping jaws that opens into the first or second narrow side.

In usual handling of the hand pliers, this results in a crimping region that is associated with a lower side or an upper side of the hand pliers. Thus, in a manner favorable in terms of handling, a cable provided with a wire end ferrule in the region of a stripped end can be inserted from the underside into the crimping region of the hand pliers with the cable end including the attached wire end sleeve being in substantially approximately upwards pointing orientation, whereafter the desired crimping takes place by plier-like actuation of the plier legs. In doing so, the hand pliers are in their orientation corresponding to the usual handling.

According to a further configuration, the first and second crimping jaws can be arranged in a common linear guide. Where necessary, the linear guide can at the same time form the crimping jaw receptacle for the second crimping jaw. The drive tappet, which is preferably connected to the movable plier leg or is acted on via the movable plier leg, acts accordingly preferably in a linearly displacing manner on the first crimping jaw, wherein in the course of a crimping via the first crimping jaw and the pressed part, where necessary, the second crimping jaw can also be displaced against the spring force within the linear guide. The linear guide can be formed by structural means directly within the hand pliers, in particular a housing of the hand pliers. Thus, with reference to a cross-section transverse to the linear displacement direction of the first crimping jaw, for example, a lateral guide on both sides preferably of both crimping jaws can be created, further preferably a guide substantially surrounding the entire circumference of the crimping jaws.

In a further configuration, the hand pliers are designed as stripping pliers, so that with the same hand pliers first a stripping of a free cable end and thereafter a crimping of this stripped cable end with, for example, a wire end ferrule can be carried out.

In particular, in order to ensure a complete crimping, i. e. a completion of the crimping process, and/or a possible stripping process, according to a possible refinement, the plier legs can interact via a positive lock. In the course of a plier actuation, this positive lock preferably permits the movement, in particular the pivoting movement, of the movable plier leg only in one direction, namely preferably the plier closing direction, up to a plier leg position in which crimping and/or stripping is safely completed. Only after this, preferably without any further additional action on the positive lock by the user, the positive lock releases the backward displacement of the movable plier leg to the basic position and thus in particular the backward displacement of the first crimping jaw to the basic position.

In a further configuration, the positive lock can also be manually released by the user after initiation of a crimping or stripping process but before the lock has reached the self-release point, preferably by adequate acting on the positive lock. Where necessary, this action can be performed without tools.

In this case, according to a preferred configuration, the positive lock can act between a control lever and the movable plier leg. In the course of the plier actuation, the control lever is preferably acted on via the movable plier leg but is preferably held so as to be relatively pivotable with respect to the movable plier leg. This relative mobility of the control lever with respect to the movable plier leg is used to form the positive lock.

In a further configuration, the positive lock can provide a ratchet-like interaction between the control lever and the movable plier leg, which, in addition to the resulting return stop, can also be perceptible as an acoustic signal, where necessary.

### BRIEF DESCRIPTION OF THE DRAWINGS

The invention is explained in more detail below with reference to the accompanying drawing which, however, merely illustrates an exemplary embodiment. In the figures:

FIG. 1 shows hand pliers of the type in question in perspective view;

FIG. 2 shows a detailed perspective view of an assignment position of a cable end to be crimped to a crimping opening of the hand pliers;

FIG. 3 shows the section according to the sectional plane III in FIG. 1, regarding the unloaded basic position of the hand pliers;

FIG. 4 shows a sectional view corresponding to FIG. 3, but regarding an intermediate position in the course of crimping;

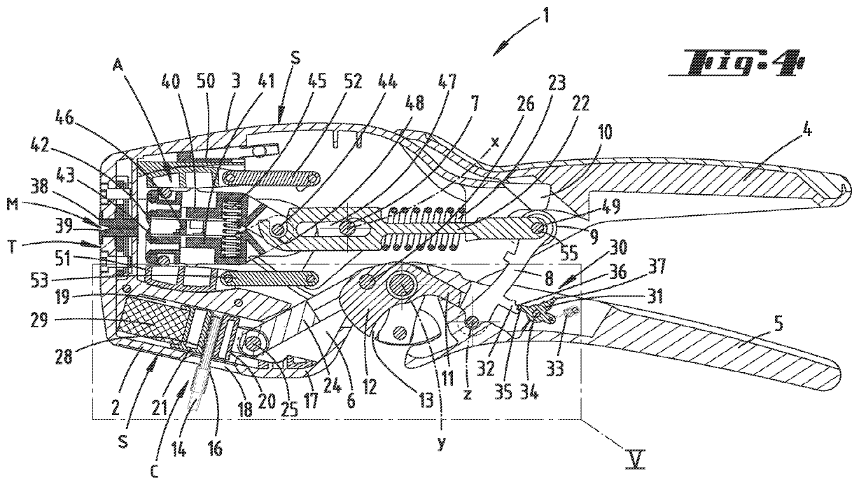

FIG. 5 shows the enlargement of region V in FIG. 4;

FIG. 6 shows a subsequent illustration to the illustration in FIG. 5, regarding a position after crimping has been carried out;

FIG. 7 shows an illustration corresponding to FIG. 5, but during crimping of a pressed part with a diameter reduced compared to the pressed part shown in FIG. 5;

FIG. 8 shows a further illustration corresponding to FIG. 5, with the diameter of the pressed part further reduced compared to the illustration in FIG. 7;

FIG. 9 shows a subsequent illustration to FIG. 3, regarding the use of the hand pliers in the course of a stripping process;

FIG. 10 shows the enlargement of the region X in FIG. 9;

FIG. 11 shows a subsequent illustration to FIG. 10, regarding an intermediate position in the course of the stripping process;

FIG. 12 shows a subsequent illustration to FIG. 11, regarding a position after completion of the stripping process.

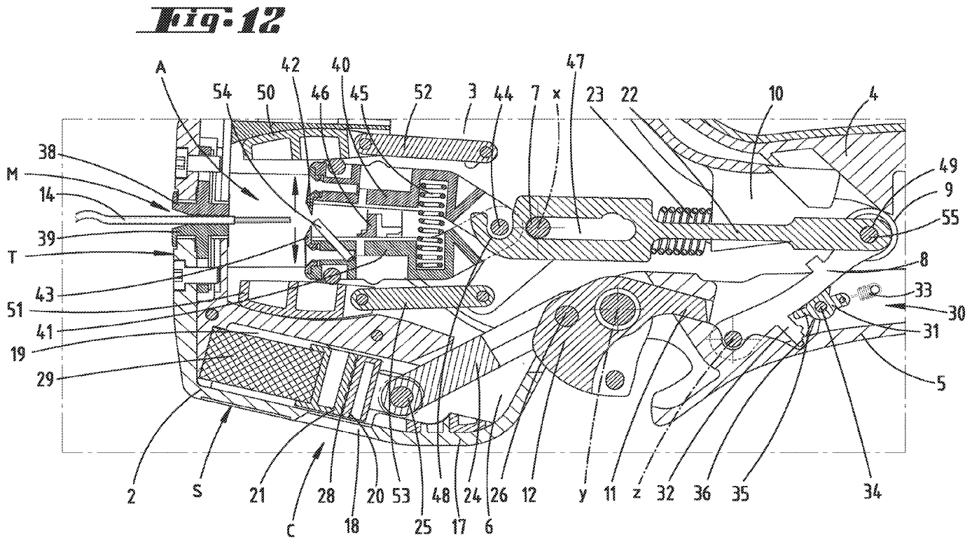

### DESCRIPTION OF THE EMBODIMENTS

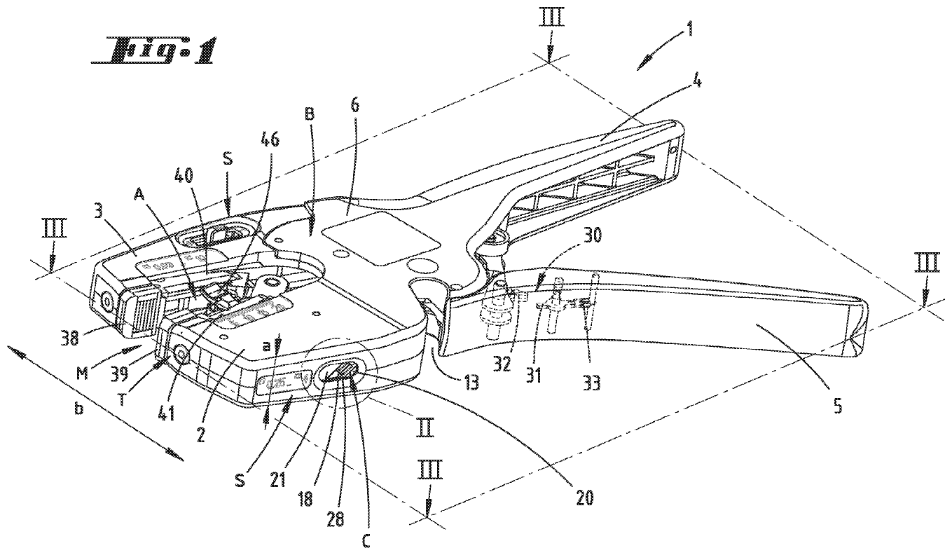

Shown and described, in the first instance with reference to FIG. 1, are hand pliers 1 with a plier head K, comprising two pliers jaws 2, 3, and two pliers legs 4, 5. The pliers jaws 2 and 3 delimit a plier mouth M in an end face T of the hand pliers 1.

The plier jaw 2, which is hereinafter referred to as stationary, is directly and fixedly connected to the plier leg 4 via a cheek region 6.

In the cheek region 6, the stripping pliers 1 provide a mounting for a pivot axle 7 with a geometric axis x, about which the movable plier jaw 3 is rotatably held.

The mounting of the movable pliers jaw 3 on the pivot axle 7 arises in the region of a shoulder region of the movable pliers jaw 3 extending in the direction of extent of the axis x in projection to the cheek region 6 of the stationary pliers jaw 3.

The geometric axis preferably extends perpendicular to a broad side B of the plier head K, to which broad side B the narrow sides S extend in the usual handling position substantially perpendicularly on the upper and lower sides, wherein the length of extent a of the narrow sides, viewed perpendicular to a broad side B, can correspond to a third or less, for example up to a tenth or less, of the length of extent b of the broad side B viewed transverse to the axis x.

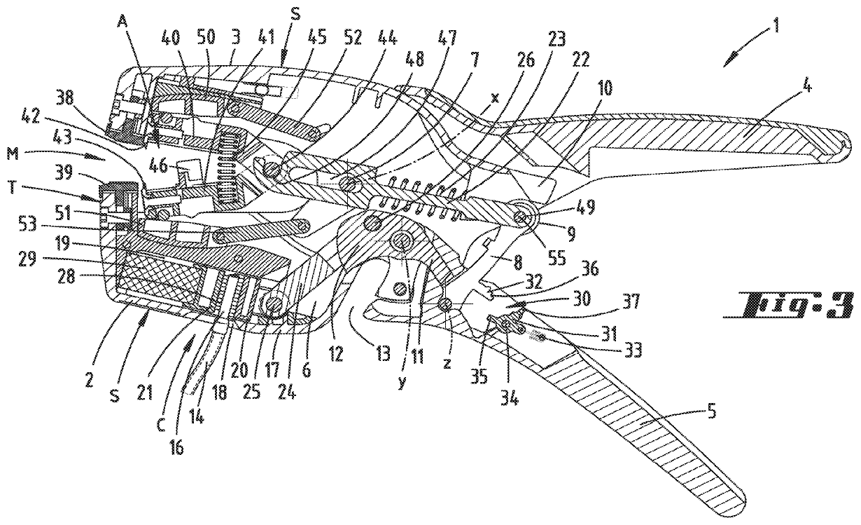

The plier jaw open position, for example according to the illustration in FIG. 3, can be stop-limited.

The further plier leg 5 is pivotally mounted about a further geometric axis y aligned parallel to the pivot axle7 or the geometric axis x thereof. The corresponding physical axle is likewise held in the cheek area 6 of the stationary plier jaw 2 or of the stationary plier leg 4.

The movable plier leg 5 is pivotable about the axis y in the direction of the stationary plier leg 4, wherein a pivoting displacement of the movable plier leg 5 in the direction of the stationary plier leg 4 causes a coupled pivoting movement of the movable plier jaw 3 about the axis x.

For this purpose, a preferably angled control lever 8 is fastened to the movable gripping part 5, which control lever rests with its free end, in the illustrated exemplary embodiment with a roller 9 preferably arranged in this region, against a cantilever 10 of the shoulder region of the movable plier jaw 3, which cantilever 10 is formed, for example, like a sliding block.

The control lever 8 is pivotably held on the movable plier leg 5. The pivot axis z in question preferably runs parallel to the geometric rotational axis x.

Furthermore, the movable gripping part 5 acts via a link 11 on a cutting edge 12 pivotally mounted in the cheek region 6 of the stationary plier jaw 2. The mounting of the cutting edge 12 takes place in the cheek region 6, with the geometric axis in question also running parallel to the geometric pivot axis x of the movable plier jaw 3.

The cutting edge 12 is exposed in a region 13 of the cheek region 6 that is cut free in the narrow side S which preferably points downwards during usual handling and is preferably used for cutting a cable to length, for example a cable to be stripped in a further step.

As a result of the pivoting movement of the cutting edge 12 in the course of the pivoting displacement of the movable plier leg 5 in the direction of the stationary plier leg 4, a cable possibly lying in the region 13 is cut through by the pivoting cutting edge 12 while supporting the cable on the flanks of the cheek region 6 which delimit the region 13.

Facing the end face T, in particular the plier mouth M, the hand pliers 1 have a stripping device A which is coupled to the movement of both the plier leg 5 and the control lever 8.

Furthermore, the hand pliers 1 facing a lower narrow side S during normal handling have a crimping device C in which a cable 14 stripped with, for example, the stripping device A can be crimped in the region of the now exposed wires 15 with a pressed part 16, in particular in the form of a wire end ferrule.

Here, as is preferred, the crimping device C can be provided between the region 13 for cutting a cable and the end face T, for which purpose a crimping opening 18 is left in the jaw wall 17 of the stationary plier jaw 2 forming the narrow side S in question.

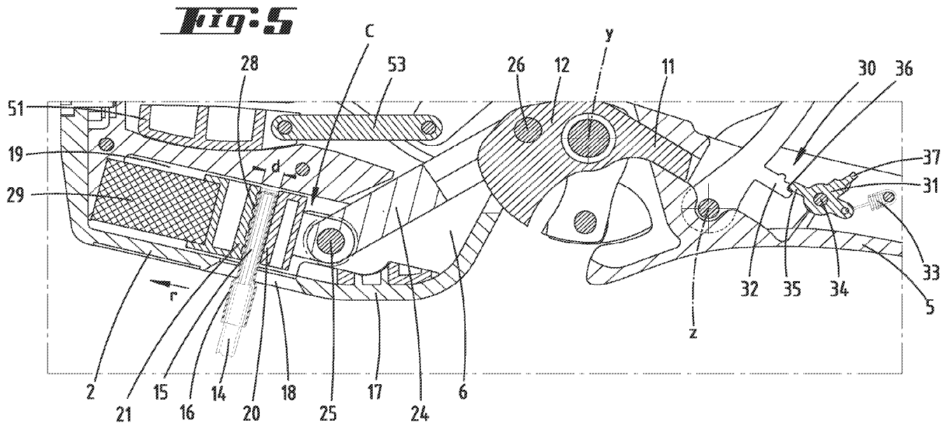

Furthermore, associated with the crimping jaw opening 18, a crimping jaw receptacle 19 is formed in the stationary plier jaw 2, in which a first crimping jaw 20 and a second crimping jaw 21 are jointly accommodated and linearly guided. A displacement direction r of the crimping jaws 20 and 21 shown, for example, in FIG. 5, as is further preferred, can be substantially in the same direction as an orientation and a displacement direction of a pull rod 22 pivotably connected to the control lever 8 and interacting with the stripping device A.

Between this pull rod 22 and the cantilever 10, a spring 23, in this case a cylinder compression spring, is preferably arranged which springs loads the movable plier leg 5 in the direction of the basic position shown in FIG. 3. In this basic position, moreover, the movable plier jaw 3 can be held in a stop-limited basic position.

In the illustrated exemplary embodiment, the second crimping jaw 21, extending from the crimp opening 18, is arranged facing the end face T and, in the course of a crimping process, is only indirectly linearly displaceable in the crimp jaw receptacle 19. The first crimping jaw 20, on the other hand, is directly linearly displaceable as a result of the action of a drive tappet 24 in the crimping jaw holder 19, which drive tappet 24 is mounted both on the first crimping jaw 20 and on the link 11 or, respectively, on the cutting edge 12 so as to be pivotable about axles 25 and 26 preferably aligned parallel to the x- and/or y- and/or z-axes. The drive tappet 24 is formed in a link-like manner.

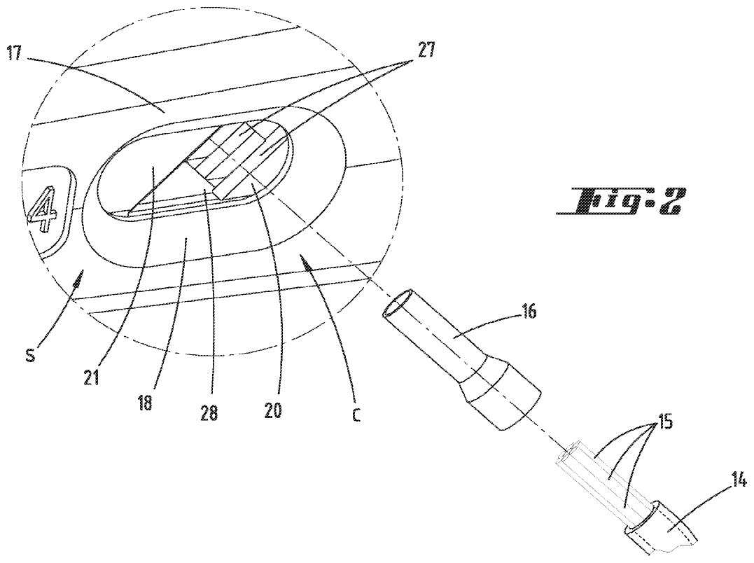

The two crimping jaws 20 and 21, as is also preferred, can be provided with ribs 27 which engage in one another in a partially comb-like manner and which are preferably approximately triangular in shape when viewed in the direction of an insertion direction of the cable 4 provided with the pressed part 16 into the crimping opening 18. In an unloaded basic position according to FIG. 3, this can result in a crimping mouth 28 which is rectangular, in particular square, in plan view (compare, for example, FIG. 2).

With regard to the rib-like configuration of the crimping jaws 20 and 21 and the resulting configuration of the crimping mouth 28, reference is made, for example, to DE 10 2018 101 159 A1. The contents of this DE publication are hereby included in full in the disclosure of the present invention, including for the purpose of incorporating features of this DE publication in claims of the present invention.

The second crimping jaw 21 guided in the crimping jaw receptacle 19 is supported in a bottom region of the crimping jaw receptacle 19 via a spring 29. This, as is also preferred, can be a resilient restorable polyurethane spring that is correspondingly compressible when acted upon thereby building up a restoring spring force.

When actuated, the plier legs 4 and 5 preferably interact via a positive lock 30. The latter preferably acts both with respect to the crimping device C and with respect to the stripping device A, and optionally also with respect to the cutting device for cutting cables using the cutting edge 12.

The positive lock 30 comprises a pawl 31 pivotally held on the movable plier leg 5, and a ratchet projection 32 on the control lever 8 interacting with the pawl 31 in the course of handling the hand pliers 1. The pawl 31 is loaded via a tension spring 33 into a basic orientation, for example according to FIG. 3.

The pawl 31, which is pivotable about an axle 34 aligned parallel to the aforementioned axes, has a substantially radially projecting pawl finger 35, for ratcheting interaction with a plurality of ratcheting steps 36, for example, as shown, three ratcheting steps 36 of the ratchet projection 32.

An actuating finger 37 can be provided which is offset from the ratchet finger 35 in the circumferential direction with respect to the axle 34 and via which the ratchet 31 can be manually pivotally displaced into a position releasing the ratchet projection 32, if necessary.

With respect to the pivotability of the pawl 31, a stop limiter can be provided in one and/or the other pivoting direction.

As a result of the positive lock 30, it is ensured during normal handling of the hand pliers 1 that the crimping process or the stripping process, or where needed the cutting process, completely finished and correspondingly a preferred end position of the respective tool is reached in each case. Before end position is reached, the interaction of the pawl 31 and the ratchet projection 32 prevents the movable plier leg 5 from moving back in the direction of the basic position and thus at the same time the movable plier jaw 3 and/or the crimping jaws 20 and 21 from moving back in the basic position. In these intermediate handling positions, the pawl finger 35 interacts with one of the ratcheting steps 36 in a locking manner.

As a result of the arrangement of the positive lock 30, a displacement travel of the first crimping jaw 20 connected to the drive tappet 24 is always of the same length, substantially irrespective of a thickness d of the pressed part 16 viewed in the displacement direction r of the crimping jaws 20 and 21. The differential travel which results in dependence on the thickness d of the pressed part 16 and over which the second crimping jaw 21 must also be displaced linearly with the first crimping jaw 20 in the displacement direction r, is made possible by the arrangement of the spring 29. The corresponding support of the second crimping jaw 21 via the spring 29 permits a different linear displacement of the second crimping jaw 21 over the differential travel, wherein according to a preferred configuration, the spring force of the spring 29 can be sufficiently high, in particular in the initial position which is preferably stop-limited with respect to the second crimping jaw 21, as shown in FIG. 3, in order to be able to absorb the pressing forces occurring during normal pressing and acting via the first crimping jaw 20. A displacement of the second crimping jaw 21 against the restoring force of the spring 29 can thus take place only after completion of the crimping or alternatively together with the crimping.

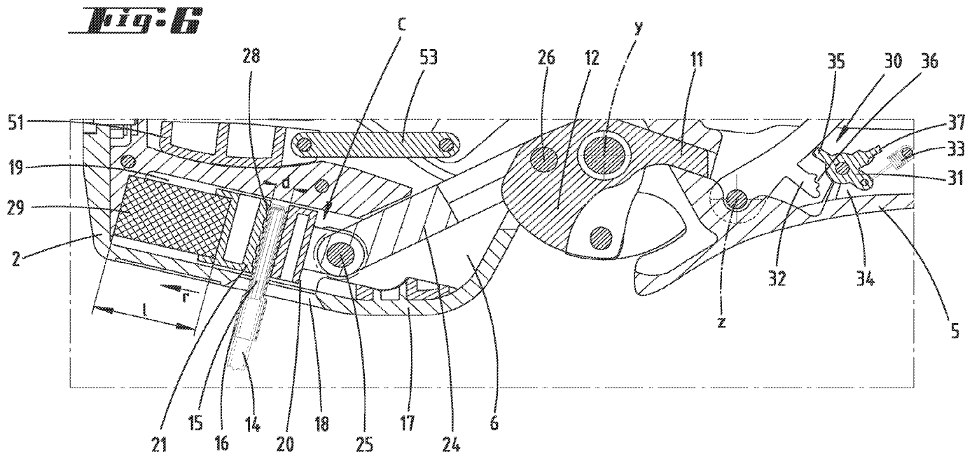

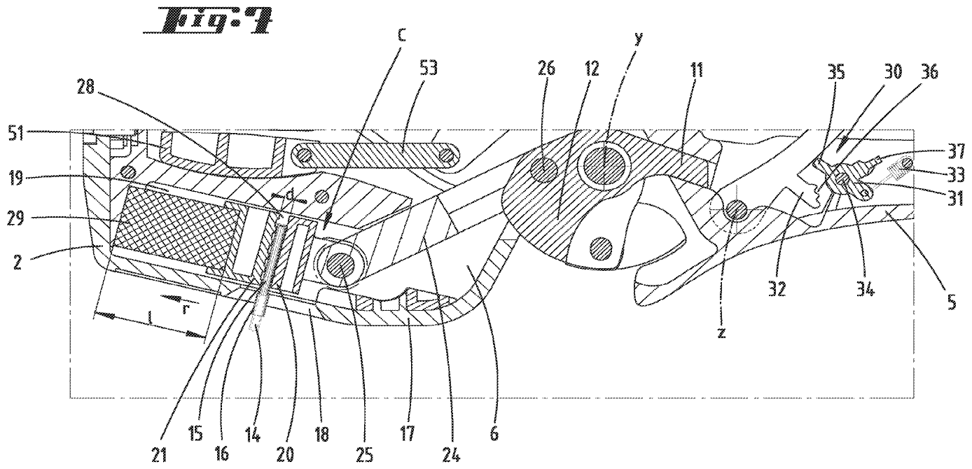

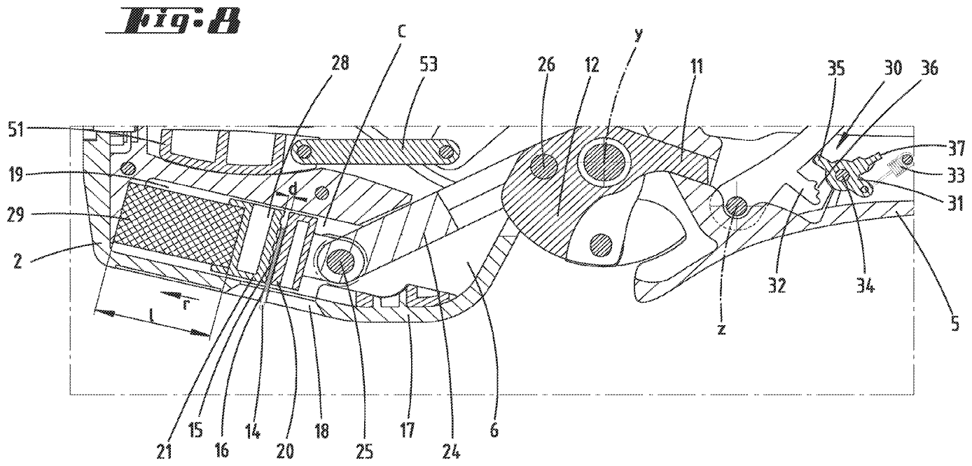

Along with the different possible displacement travels of the second crimping jaw 21 in dependence on the thickness d of the pressed part 16 to be pressed, different lengths 1 of the spring 29 in the crimped end position occur, wherein this length 1 decreases with increasing thickness d of the pressed part 16 (compare in particular FIGS. 6 to 8). Correspondingly, increasing thickness d of the pressed part 16 results in higher compression of the spring 29 to compensate in particular for the second crimping jaw's 21 displacement travel which is forced via the positive lock 30.

In the course of the crimping process, a center of the crimping mouth 28 resulting between the crimping jaws moves relative to the stationary plier jaw 2.

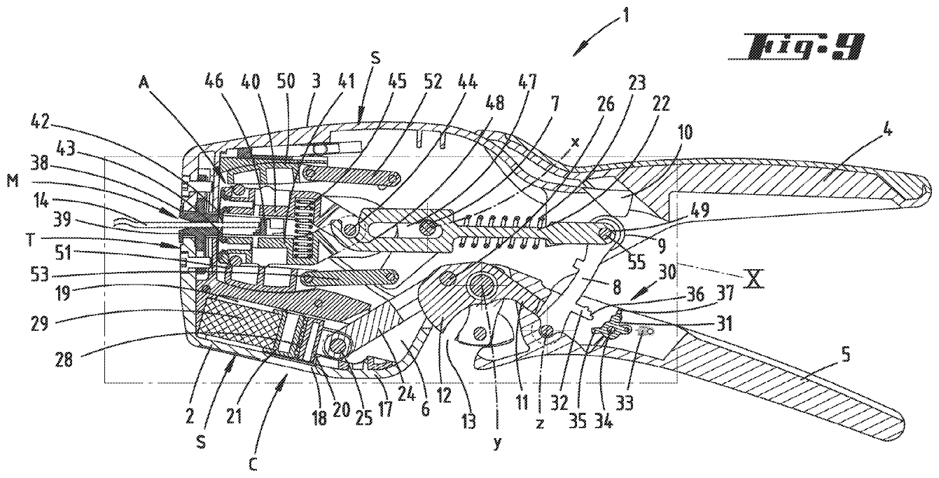

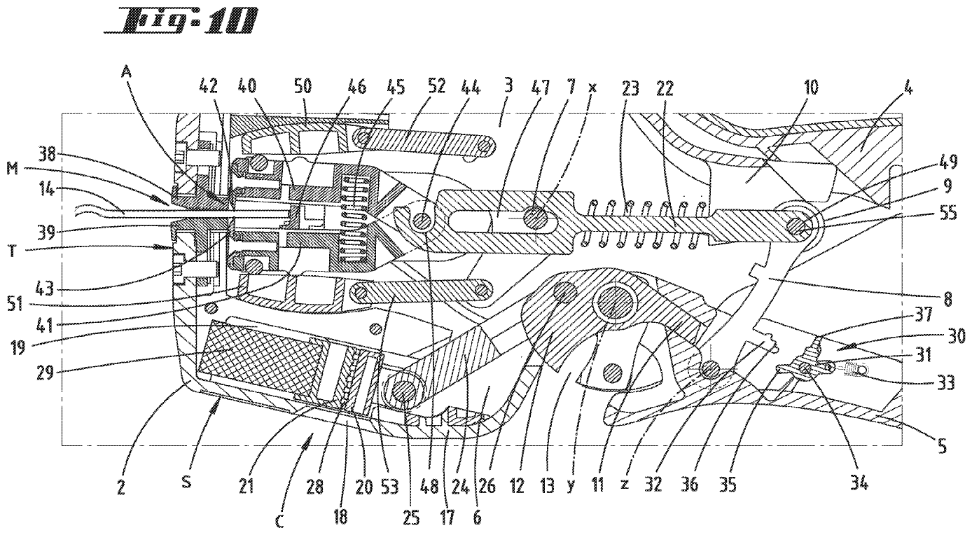

The two plier jaws 2 and 3 each further comprise an outer clamping jaw 38, 39 for clampingly gripping a cable 14 inserted into the plier mouth M for stripping a free end, compare also FIGS. 9 to 10.

Furthermore, with respect to the arrangement of the clamping jaws 38 and 39 relative to the geometric rotational axis x, two inner cutting jaws 40, 41 are provided, each having cutting edges 42, 43 fixed in end regions facing the clamping jaws 38 and 39. The cutting edges 42 and 43 are arranged facing each other.

The geometric axis of the pivot axle 44 preferably extends in parallel direction to the pivot axis x of the movable plier jaw 3 in the operational arrangement of the pair of cutting jaws.

A spring 45 is arranged between the cutting jaws 40 and 41, which spring 45 loads the cutting jaws 40 and 41 into a mutually spaced open position.

In the illustrated exemplary embodiment, a stop slide 46 which can be latched in place in the direction of extent of the plier jaw 41 is provided on the lower plier jaw 41, i. e., on the plier jaw 41 associated with the stationary plier jaw 2, for offering a stop for the free end of the cable 14 inserted into the plier jaw M in order to define in this manner the length of the region to be stripped.

The cutting jaws 40 and 41 are laterally guided in the respective associated plier jaw 2, 3, for enabling a proper sliding displacement of the cutting jaws 40 and 41 in the direction of their longitudinal extent, i. e., extending from an initial position associated with the clamping jaws 38 and 39 in the direction of an end position spaced apart from the clamping jaws 38 and 39 and displaced in the direction of the pivot axis x, and from this end position back again to the initial position.

For this displacement of the cutting jaws 40, 41, the pull rod 22 is provided. In the course of pressing the gripping parts 4, 5 together, the cutting jaws 40, 41 can be displaced from an initial position to an end position against the force of the spring 23 acting on the pull rod 22.

The pull rod 22 is also guided by passing through an elongated hole-like recess 47 through the physical pivot axle 7 on the pull rod side.

Associated with the pivot axle 44 of the pair of cutting jaws, the pull rod 22 has an entry opening 48 directed substantially in the direction of the stationary plier jaw 2, and moreover substantially in the closing or opening direction of the cutting jaws 40 and 41. The entry opening is created by a generally hook-like configuration of the end region of the pull rod 22 in question.

In the usual position of use of the hand pliers 1, the pivot axle 44 of the pair of cutting jaws lies in this entry opening 48, so that a sliding displacement of the pull rod 22 made possible due to the elongated hole-like configuration of the recess 47 results in a corresponding sliding displacement of the pair of cutting jaws.

This sliding displacement of the pull rod 22 is made possible via a coupling with the control lever 8 held on the movable gripping part 5, which control lever 8 engages in a bore 49 on the pull rod side with a pull axle 55 which is aligned parallel to the pivot axle 7 and which in the illustrated exemplary embodiment can also form the axle for the roller 9.

Each cutting jaw 40, 41 is supported in the associated plier jaw 2, 3 via a sliding block part 50, 51, which sliding block part 50, 51 can in turn be supported on a sliding block fixed to the clamping jaw.

This indirect support of the cutting jaws 40, 41 on the respective plier jaw 2, 3 is known, for example, from EP 1 557920 B1. With respect to the mode of operation, reference is also made to the contents of this patent specification.

In the course of pressing the plier jaws 4 and 5 together, in the first instance, a closing of the plier jaw mouth M according to a corresponding pivoting displacement of the movable plier jaw 3 while superimposing a closing of the pair of cutting jaws is carried out (compare FIGS. 9 and 10). The cutting edges 42 and 43 of the cutting jaws 40 and 41 cut into the insulation sheath of the cable 14 with a cutting depth which is preferably automatically adjusted in dependence on the cable thickness.

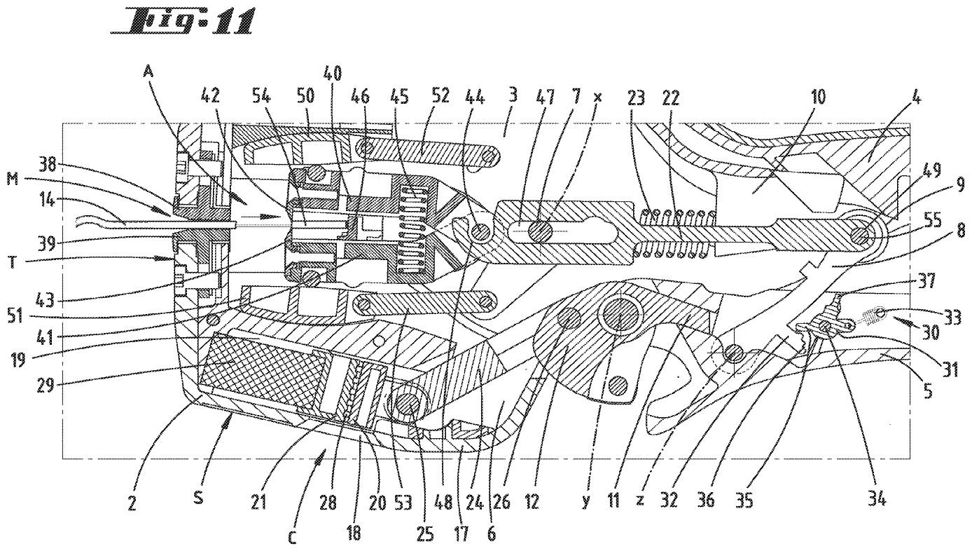

Upon further pivotal displacement of the movable plier leg 5 in the direction of the stationary plier leg 4 as shown in FIG. 11, the roller 9 of the cantilever 10 slides along the facing and aforementioned end face of the cantilever 10 while overcoming the restoring force of the spring 23 acting on the pull rod 22. The pull rod 22 is pulled linearly in a direction moving away from the plier mouth M, dragging along the pair of cutting jaws. This causes the insulation portion 54, separated by cutting by means of the cutting edges 42 and 43, to be stripped from the cable 14.

Upon further pressing the plier legs 4 and 5 together, the roller 9 at the cantilever leaves the supporting position to the cantilever 10 of the movable plier jaw 3 which pivots back in the direction of its open basic position while simultaneously opening the plier jaw mouth M as well as the pair of cutting jaws. This is caused, among other things, by the restoring force of the spring 45 provided between the cutting jaws 40 and 41.

The cable 14 stripped at the end is exposed for removal from the hand pliers 1. The cut and stripped insulation portion 54 is exposed for removal or possibly falls automatically from the jaws M of the pliers.

Subsequently, the end of the cable that is stripped and, for example, is provided with a wire end ferrule can be crimped or pressed with the same hand pliers 1.

Reference list

| | | | |
|---|---|---|---|
| 1 | hand pliers | 30 | positive lock |
| 2 | plier jaw | 31 | pawl |
| 3 | plier jaw | 32 | ratchet projection |
| 4 | plier leg | 33 | tension spring |
| 5 | plier leg | 34 | axle |
| 6 | cheek region | 35 | pawl finger |
| 7 | pivot axle | 36 | ratcheting step |
| 8 | control lever | 37 | actuation finger |
| 9 | roller | 38 | clamping jaw |
| 10 | cantilever | 39 | clamping jaw |
| 11 | link | 40 | cutting jaw |
| 12 | cutting edge | 41 | cutting jaw |
| 13 | region | 42 | cutting edge |
| 14 | cable | 43 | cutting edge |
| 15 | wire | 44 | pivot axle |
| 16 | pressed part | 45 | spring |
| 17 | jaw wall | 46 | stop slide |
| 18 | crimp opening | 47 | recess |
| 19 | crimp jaw receptacle | 48 | entry opening |
| 20 | first crimp jaw | 49 | bore |
| 21 | second crimp jaw | 50 | slide block part |
| 22 | pull rod | 51 | slide block part |
| 23 | spring | 52 | link |
| 24 | drive tappet | 53 | link |
| 25 | axle | 54 | insulation portion |
| 26 | axle | 55 | pull axle |
| 27 | rib | | |
| 28 | crimping mouth | a | length |
| 29 | spring | b | length |
| d | thickness | | |
| l | length | | |
| r | displacement direction | | |
| A | stripping device | | |
| B | broad side | | |
| C | crimping device | | |
| K | plier head | | |
| M | plier mouth | | |
| S | narrow side | | |
| T | end face | | |

1. Hand pliers (1), designed to carry out crimping, having one stationary and one movable plier leg (4, 5) and a first and a second crimping jaw (20, 21), wherein the first crimping jaw (20) is acted on by a drive tappet (24), wherein the first and the second crimping jaw (20, 21) are provided with ribs (27) which engage in one another in a partially comb-like manner and which are preferably approximately triangular in shape when viewed in a direction of an insertion direction of a cable (4) provided with a pressed part (16) into the crimping opening (18), wherein in an unloaded basic position, a resulting crimping mouth (28) that is rectangular in plan view is obtained, wherein the second crimping jaw (21) is configured to be moved back inside a crimping jaw receptacle (19) of the hand pliers (1) against spring force, and wherein the first and the second crimping jaws (20,21) are arranged in a common linear guide.

2. The hand pliers (1) according to claim 1, further comprising a plier head which is formed by mutually pivotable plier jaws (2, 3) which interact for stripping, wherein the plier head has a broad side (B), a first and a second narrow side(S) extending in a usual handling position on the upper and lower sides substantially at right angles to the broad side, and an end face (T), wherein further a pivot axis (x) of the plier jaws (2, 3) extends at right angles to an extent of the broad side (B), wherein a crimping opening (18) formed by the crimping jaws (20, 21) opens into the narrow side(S).

3. The hand pliers according to claim 1, wherein the hand pliers (1) are further designed as stripping pliers.

4. (canceled)

5. The hand pliers according to claim 1, wherein the plier legs (4, 5) interact via a positive lock (30).

6. The hand pliers according to claim 5, wherein the positive lock (30) acts between a control lever (8) and the movable plier leg (5).

7. (canceled)
